(19) United States
(12) Patent Application Publication
(10) Pub. No.: US 2025/0278623 A1
(43) Pub. Date: Sep. 4, 2025

(54) DE-BIASING FRAMEWORK FOR DEEP LEARNING MODELS

(71) Applicant: Microsoft Technology Licensing, LLC, Redmond, WA (US)

(72) Inventors: Hailing Cheng, San Jose, CA (US); Yafang Yang, Santa Clara, CA (US)

(21) Appl. No.: 18/592,404

(22) Filed: Feb. 29, 2024

(51) Int. Cl. G06N 3/08

(52) U.S. Cl. CPC G06N 3/08

(57) ABSTRACT

Embodiments may use a score prediction tower of a deep learning model to generate and output predicted relevance scores for respective content items, use a bias prediction tower of the deep learning model to generate and output bias prediction embeddings, and use an isotonic layer of the deep learning model to combine the relevance scores output by the score prediction tower with the bias prediction embeddings output by the score prediction tower. Embodiments may, by the isotonic layer, and output de-biased versions of the relevance scores based on the combination of the relevance scores with the bias prediction embeddings. Embodiments may provide the de-biased versions of the relevance scores for use by at least one application, system, model, service, process, or device.

### TECHNICAL FIELD

A technical field to which this disclosure relates includes deep learning-based recommendation systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

### BRIEF DESCRIPTION OF THE DRAWINGS

The disclosure will be understood more fully from the detailed description given below and from the accompanying drawings of various embodiments of the disclosure. The drawings are for explanation and understanding only and should not be taken to limit the disclosure to the specific embodiments shown.

FIG. 1 is a flow diagram of an example method for generating de-biased recommendations using a combined scoring and de-biasing model in accordance with some embodiments of the present disclosure.

FIG. 2 is a flow diagram of an example method for training a combined scoring and de-biasing model in accordance with some embodiments of the present disclosure.

FIG. 3 is a flow diagram of an example method for generating predictions using a combined scoring and de-biasing model in accordance with some embodiments of the present disclosure.

FIG. 4 illustrates an example of an isotonic function in accordance with some embodiments of the present disclosure.

FIG. 5 illustrates example deep learning implementations of an isotonic function in accordance with some embodiments of the present disclosure.

FIG. 6 is a block diagram of a computing system that includes a combined scoring and de-biasing model in accordance with some embodiments of the present disclosure.

FIG. 7 is a flow diagram of an example method for generating predictions using a combined scoring and de-biasing model in accordance with some embodiments of the present disclosure.

FIG. 8 is a block diagram of an example computer system including components of a combined scoring and de-biasing model in accordance with some embodiments of the present disclosure.

### DETAILED DESCRIPTION

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier (e.g., ramp, ReLU (Rectified Linear Unit)) functions.

The input layer of a deep neural network receives and processes the model input, which can include raw data and/or pre-processed data such as aggregations, derivations, embeddings or vector representations of raw data. The output of a layer of the neural network can be connected to and used as the input to another layer, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values can be adjusted so that the outputs of some nodes or layers influences the final output more or less than the outputs of other nodes or layers. The output layer of the neural network produces the final predictive output, which can be made accessible to one or more downstream models, applications, systems, operations, processes or services.

Backpropagation is an example of a method that can be used to iteratively train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) may be used in backpropagation.

Recommendation systems can apply deep learning models to generate predictions and use those predictions to configure one or more downstream operations. For example, recommendation systems compute statistical or probabilistic predictions that can be used to select, rank, or sort digital content items for presentation to users via electronic devices. Examples of downstream operations that can use the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In recommendation systems and other machine learning applications, prediction accuracy is a crucial component of the model output. Low or unstable prediction accuracy can have adverse consequences ranging from the display of irrelevant, inappropriate, or biased information to users of an online system to erroneous control signals or operational decisions of an automated system due to biased predictions.

In recommendation systems, there are different types of bias that can adversely affect prediction accuracy. System bias may refer to a bias that is induced by the recommendation system itself, e.g., bias in the ranking function used by the recommendation system to sort or filter potential recommendations. Exposure bias may refer to a bias induced by a user's exposure to certain recommendations but not others; e.g., an implicit assumption that the recommendations to which a user is exposed are better than other recommendations to which the user is not exposed. User bias may refer to biases that are induced by the user or by some element of the presentation of recommendations. Examples of user bias include positional bias (presentation bias), trust bias, conformity bias and selection bias.

Position bias is a commonly encountered bias in recommendation systems that requires careful handling during the modeling process. Position as used herein refers to a position at which a recommendation is presented to a user, such as a spatial position on a two or three dimensional user interface display (e.g., x-y or x-y-z coordinates) or a temporal position in audio or visual output (e.g., recommendation r1 is presented at time t1, recommendation r2 is presented at time t2, and so on). For example, a news feed may have multiple positions (or slots) at which recommendations may be presented via a user interface, such that recommendations are assigned to positions in rank order with the most relevant recommendation being placed in the top (or highest visibility) position. For instance, a 0 position in a feed may refer to the slot at the top of a list, such that the recommendation that is assigned to the 0 position is the first recommendation to be presented to the user. Similarly, a recommendation that is assigned to the 5 position would be the fifth recommendation to be presented to the user in the feed.

Typically, recommendation systems aim to assign the most relevant recommendation to the 0 position and then assign other recommendations to subsequent positions in descending order of relevance. Apart from relevance, due to human nature, habit, convenience, user interface design, or other factors (e.g., factors unrelated to relevance), the probability that users will view or engage with recommendations that are presented in the top slots may be higher than the probability that those users will view or engage with recommendations that are presented in lower slots (slots associated with greater position numbers, e.g., position 5, 10, or 20), simply because of the order of presentation, regardless of the relevance of those recommendations. Position bias can adversely affect evaluations of a model's prediction accuracy in that position bias can artificially inflate estimations of prediction accuracy that are based on user interactions (e.g., whether users clicked or did not click on a recommendation) because relevance is confounded with position bias.

Bias can be introduced to deep learning models during the model training process. For example, the way in which training data is selected and/or labeled can bias the models' resulting predictions. In supervised machine learning, the training data includes ground truth labels that provide the model with information about expected or actual relationships between certain types of data. Thus, in the case of content recommendations, position bias becomes an issue if the data used to train a relevance model includes engagement information (e.g., whether a user viewed or did not view a content item) as an indicator of relevance.

One prior approach to handling position bias involves using position as a feature during the training stage of deep learning models, but setting the position value to 0 during inference using the trained model. Dropout is applied to the position features to prevent overfitting. However, determining the dropout ratio requires labor-intensive manual tuning and A/B testing. Moreover, this approach is sub-optimal for model learning because the training involves a logit-wise addition. Additionally, this approach is challenged by the potential for overfitting of positional features and struggles to accommodate systems where specific positions serve distinct purposes. For instance, a certain slot, such as slot N, where N is a positive integer, might primarily be allocated for a specific purpose, such as a personalized recommendation or a specific type of product recommendation, and these distinctions are not well represented in the training data.

Another prior approach is to compute propensity scores using an offline model for different positions and then incorporate these scores into the recommendation model. This can be achieved through either negative reweighting or co-training the propensity score with the recommendation model. Implementing this approach requires either utilizing random session data to compute the propensity score or introducing an additional modeling step for co-training the two models. Further, this approach requires additional steps, such as pre-computing the inverse propensity weighting (IPW) using random data or co-training another model/statistics with the deep learning model. These additional complexities introduce technical challenges to the modeling process. For example, in the case of multi-task modeling, addressing positional bias requires computing distinct inverse propensity weighting (IPW) scores for various events, which further complicates the training process of the entire model.

To address these and other technical challenges, the described approaches introduce an isotonic layer that treats the de-biasing problem as a calibration issue. Isotonic regression refers to a technique of fitting a free-form line to a sequence of observations such that the fitted line is non-decreasing (or non-increasing) everywhere, and lies as close to the observations as possible.

Existing methods for model calibration include Platt Scaling and piecewise fitting. Drawbacks of Platt Scaling include a small model parameter space that is insufficient for complicated use case, and underfitting. Piecewise fitting has a sufficiently large model parameter space but is not compatible with deep learning. As a result, piecewise fitting requires the use of separate models for training and calibration. Furthermore, piecewise fitting does not scale well. For example, when model scores need to be calibrated for a large number of sources of input (e.g., tens or hundreds of thousands or millions of content providers supplying digital content) piecewise fitting would require the training of a separate calibration model for each source of input (e.g., each content provider). The need for so many separate calibration models is sub-optimal because the computing resources (e.g., memory, computational capacity, etc.) would need to be scaled linearly with the number of models.

The described approaches overcome the disadvantages of the prior calibration methods by incorporating a generic, isotonic calibration layer directly into the deep learning model architecture to create a combined (or unified) scoring and de-biasing model that can scale easily within an existing deep learning framework (e.g., without requiring additional models). The isotonic layer as described performs calibration of the last layer of the traditional deep learning model using learned calibration parameters. Embodiments of the described approaches provide a multi-tower deep learning architecture that includes a recommendation (or score prediction) tower, a de-biasing (or bias prediction) tower, and an isotonic (or calibration) layer, where, as described in more detail below, both towers are trained together using different feature from the same overall training dataset. In other words, the different feature sets used to train the score prediction tower and the bias prediction tower both contain features that are associated with the same training dataset, which may pertain to a set of entities, e.g., users and content items. As such, these feature sets can originate as a single training set that is appropriately divided into the respective feature sets, across the towers, at training time. The final output of the recommendation tower and the final output of the de-biasing tower are both input to the isotonic layer, and the isotonic layer produces the final, de-biased output.

Terminology such as de-biased, de-biasing, or de-bias, as used herein, may refer to a complete or partial removal or reduction of bias. For example, while some embodiments can function to remove bias completely, e.g., to generate relevance scores that are without one or more particular types of bias, other embodiments can operate to reduce or minimize bias without, perhaps, removing the bias entirely.

The disclosed approach avoids the limitations of prior approaches, mentioned above, and is considerably simpler than prior de-biasing solutions. Moreover, the disclosed approaches can be easily extended to listwise model training and/or to multi-task training with minimal difficulty. Further, the described approaches are agnostic as to the type of bias or biases that are addressed, and are not limited to position bias. For example, the described approach can be extended to accommodate other forms of bias in addition to position bias or in the alternative. As well, while feed position is used to illustrate aspects of the described approaches, the disclosed approaches are not limited to feeds but can be used with many other forms of presentation mechanisms that provide at least two different options for the presentation of content items, from which one of the available options is selected for each item. Additionally, the described approaches are not limited to recommendation models but can be extended to other types of deep learning models.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

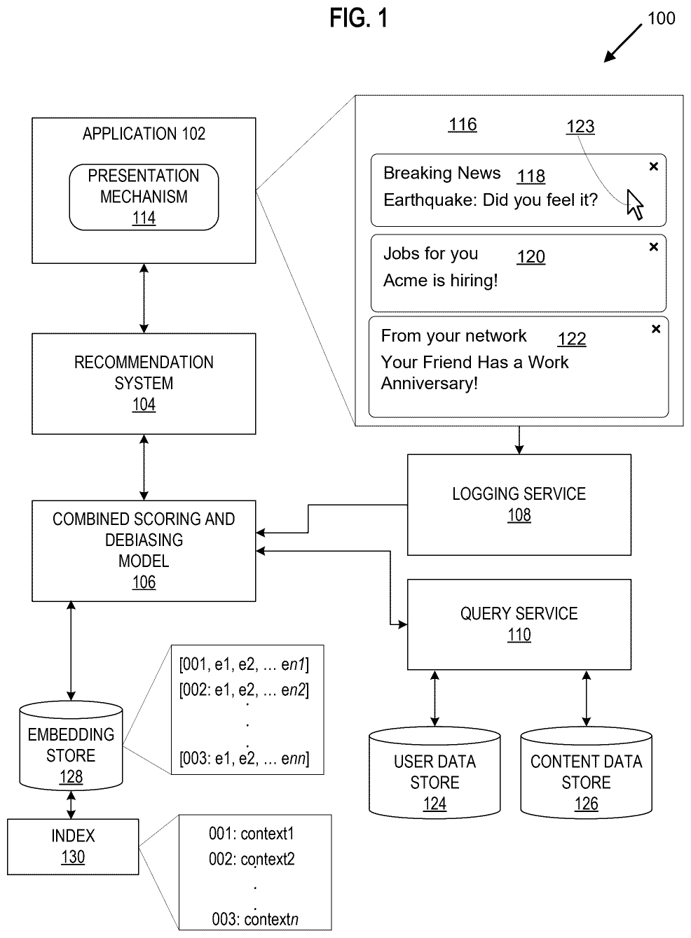

FIG. 1 is a flow diagram of an example method for generating de-biased recommendations using a combined scoring and de-biasing model in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a combined scoring and de-biasing model, including, in some embodiments, components or flows shown in FIG. 1 that may not be specifically shown in other figures and/or including, in some embodiments, components or flows shown in other figures that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

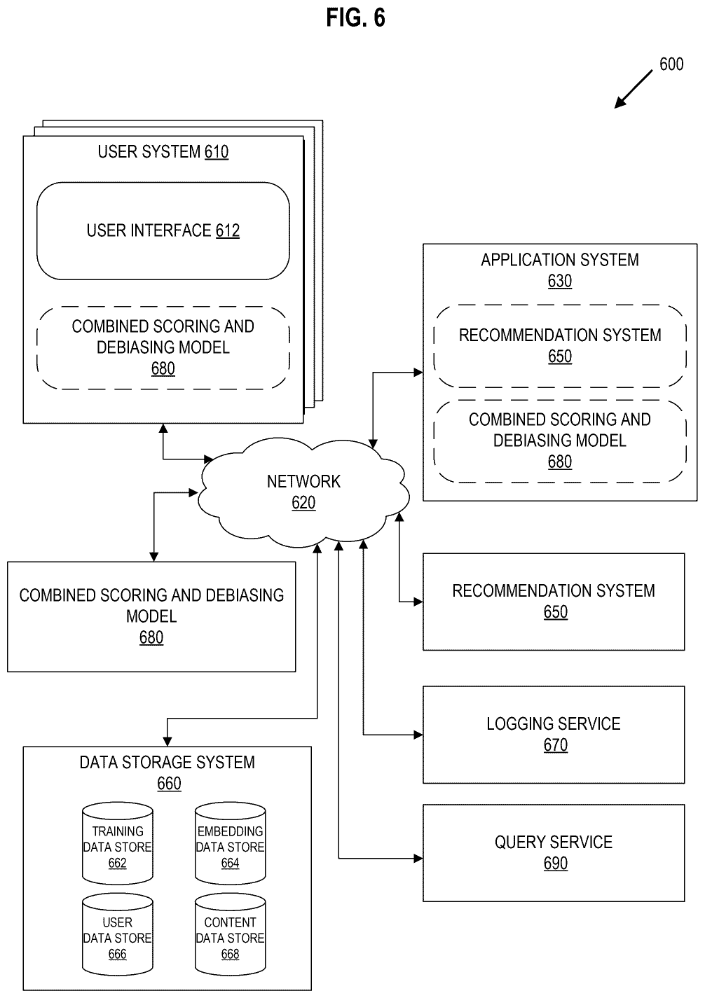

In FIG. 1, the method is performed by an example computing system 100, which includes an example combined scoring and de-biasing model 106. In the example of FIG. 1, the components of the combined scoring and de-biasing model are implemented using an application server or server cluster, which can include a secure environment (e.g., secure enclave, encryption system, etc.) for the processing of data. In some implementations, one or more components of the combined scoring and de-biasing model are implemented on a client device, such as a user system 510, described herein with reference to FIG. 6, running an application 105, alone or in combination with one or more servers. For example, some or all of combined scoring and de-biasing model is implemented directly on the user's electronic device in some implementations, thereby avoiding the need to communicate with servers over a network such as the Internet. In some implementations, the combined scoring and de-biasing model is in bidirectional communication with one or more applications via a computer network. The one or more applications include front end user interface functionality that, in some embodiments, is considered part of or is in communication with combined scoring and de-biasing model, e.g., application 105.

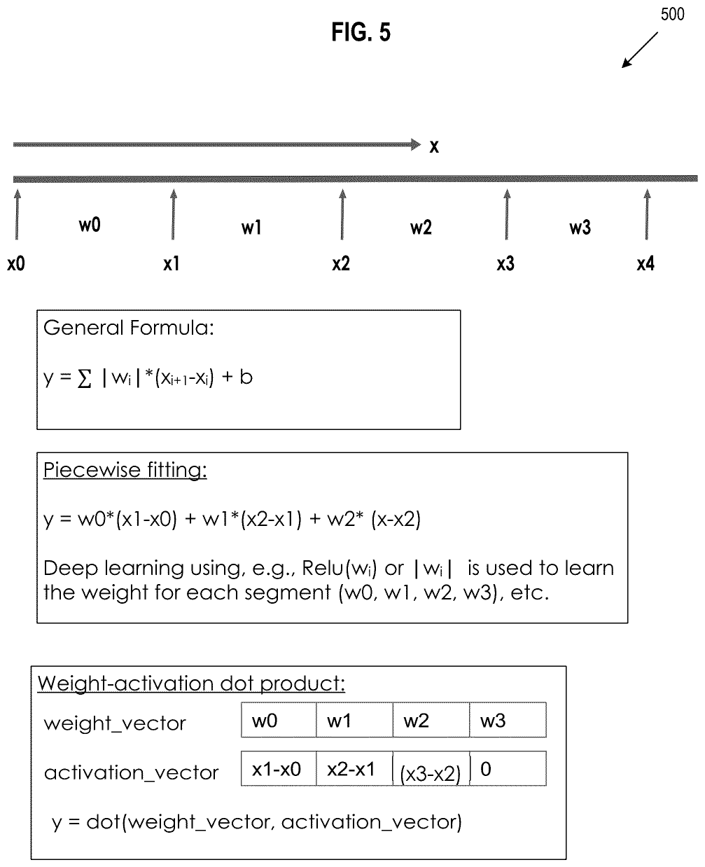

In the embodiment of FIG. 1, the computing system 100 includes an application 102, a recommendation system 104, a combined scoring and de-biasing model 106, a logging service 108, a query service 110, a user data store 124, and a content data store 126. Additional structural details of each of application 102, recommendation system 104, combined scoring and de-biasing model 106, logging service 108, query service 110, user data store 124, and content data store 126 are described below, for example with reference to FIG. 5.

Application 102 includes a presentation mechanism 114. In operation, presentation mechanism 114 causes presentation of a set of content items at an electronic device. In the example of FIG. 1, the presentation is in the form of a visual display, e.g., a feed 116, but other implementations having at least two potential alternative positions for presentation of a content item are possible. The feed (or other form of presentation) 116 contains a number of presentation positions at which content items are presented. In the example of FIG. 1, content item 118 is presented at a first position, content item 120 is presented at a second position, and content item 122 is presented at a third position. The number of available presentation positions can be constrained by one or more aspects of the computing environment and/or other factors. For example, a mobile device environment with a relatively small display screen may have fewer available positions than a laptop or desktop environment having a larger display screen. As another example, a message inbox may have more available positions than a notification center or a list presented via machine-generated audio. The assignment of content items to positions can be based on relevance to user preferences, recency, and/or other factors.

The logging service 108 logs signals that are received from the application 102, or more particularly from the presentation mechanism 114, as the user interacts with the feed (or other presentation mechanism) 116. For example, the user may activate a selection mechanism 123 at the first position to view the content item 118 or the user may scroll through the feed without selecting any content items. Logging service 108 tracks signals by presentation position. For instance, if the user selects content item 118, logging service 108 may log [0, 1], indicating that a positive signal was received at position zero (the position with the highest likelihood of user attention) of the feed. If instead the user keep scrolling past content item 118 without selecting content item 118, logging service 108 may log [0,0], indicating that a negative signal or no signal was received at position one of the feed. Logging service 108 continues to log position-based signals throughout the user's login session.

Logging service 108 generates an interaction log such as the example described above for each session of each user of application 102. As such, an interaction log can contain any amount of interaction data collected over a time interval of any duration for any number of users. For example, an interaction log can contain information about the operational context, e.g., computing environments, associated with the interaction data, such as whether the interaction occurred on a mobile device or larger computer, or whether the interaction occurred within a browser version of the application 102 or a mobile “app” version of the application 102. As such, the interaction data can be grouped or filtered by one or more contextual or computing environment parameters. From time to time, as described in more detail below, combined scoring and de-biasing model 106 obtains position-based interaction data from logging service 108.

In operation, recommendation system 104 generates and supplies recommendations, such as content item rankings, to application 102. Presentation mechanism 114 assigns content items to presentation positions of feed (or other presentation mechanism) 116 based on the content item rankings generated by recommendation system 104. The assignment of content items to presentation positions is on one-to-one basis in that a content item is assigned to only one presentation position at a time, and a presentation position has only one assigned content item at a time.

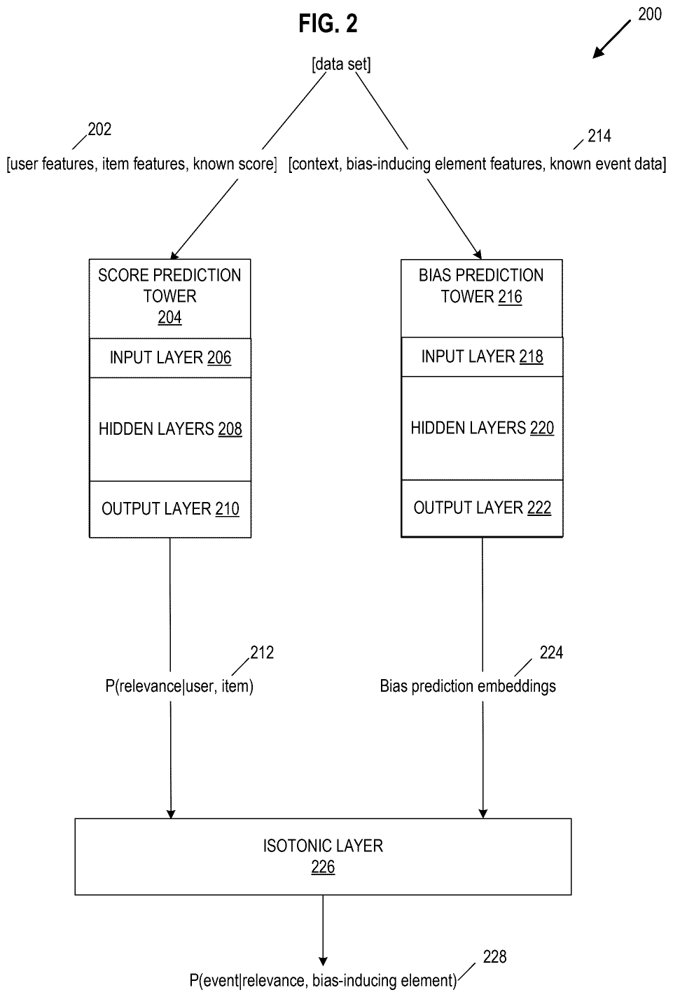

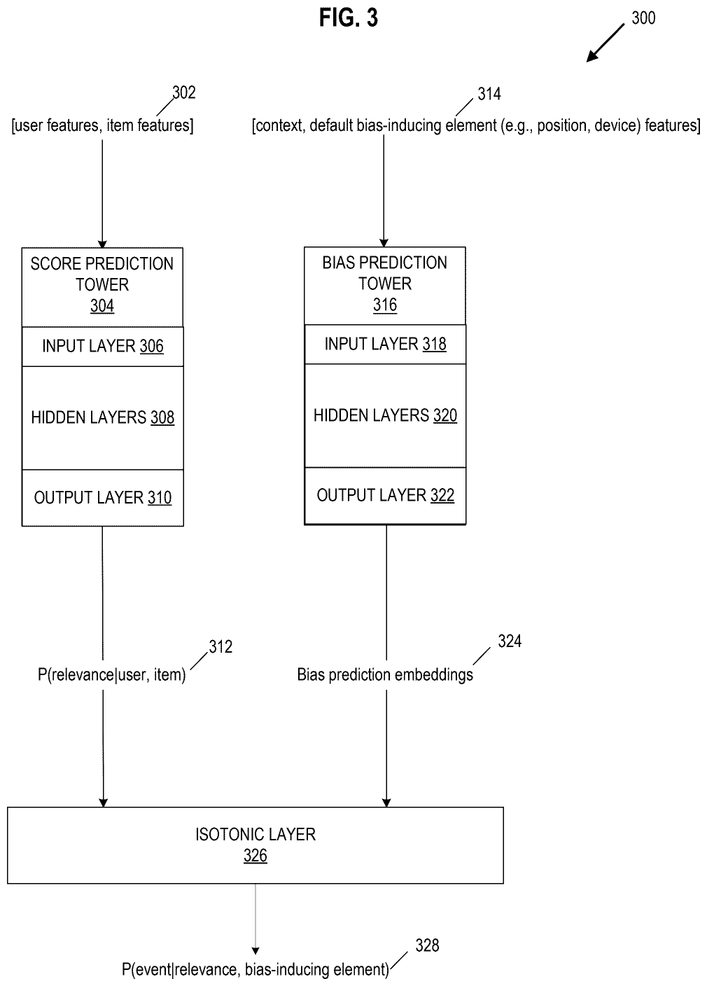

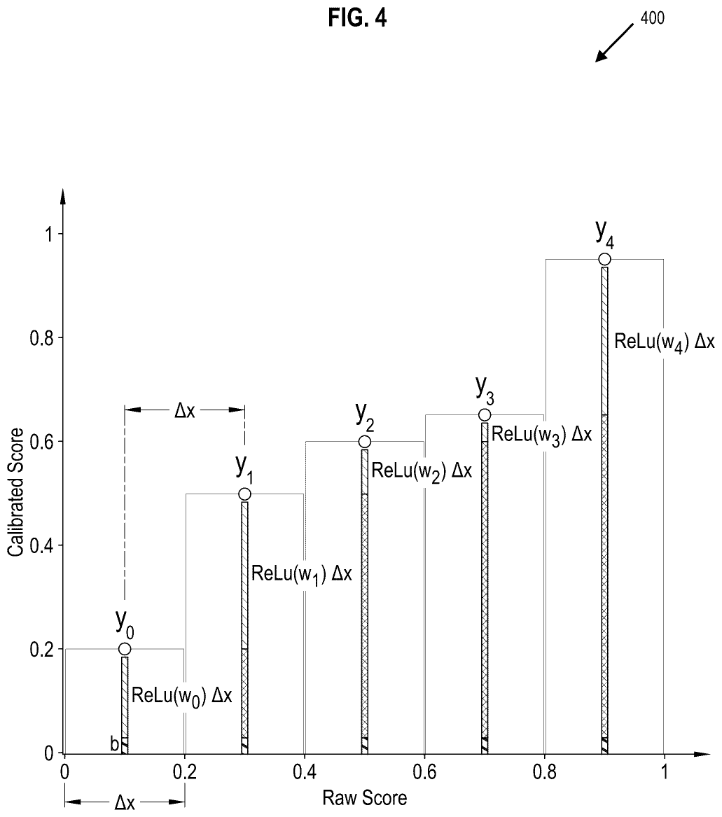

To generate the content item rankings, recommendation system 104 interfaces with combined scoring and de-biasing model 106. Combined scoring and de-biasing model 106 generates de-biased relevance scores for content items using the techniques described herein. Examples of the architecture, training, and use of a combined scoring and de-biasing model 106 are described in more detail below with reference to FIG. 2, FIG. 3, FIG. 4, and FIG. 5.

The inputs to combined scoring and de-biasing model 106 include position-based interaction data collected by logging service 108, content item features and user features. Content features can be obtained via query service 110 querying and retrieving information from a content data store 126, and user features can be obtained via query service 110 querying and retrieving information from a user data store 124, for example.

In more detail, embodiments of combined scoring and de-biasing model 106 compute a position-neutral relevance score for each content item in a set of content items that potentially can be presented to the user. The position-neutral relevance score is computed based on features of the user data and features of the content item, without reference to the potential presentation positions and without regard for any features that may be associated with the potential presentation positions. Feature as used herein may refer to data that represents various characteristics of the user or content item as the case may be, such as user preferences, user profile information, topics or categories associated with content item, metadata, etc.

In addition to computing position-neutral relevance scores, combined scoring and de-biasing model 106 also determines a predicted bias associated with each presentation position that is available via presentation mechanism 114. Combined scoring and de-biasing model 106 then calibrates (or de-biases) the position-neutral relevance score using the position-specific predicted bias. Combined scoring and de-biasing model 106 typically performs these computations for many different users and many different user-content item pairs and provides the de-biased relevance scores to recommendation system 104.

While this disclosure refers to user-content item pairs to illustrate embodiments of the disclosed approaches, the approaches are not limited in application to matching users with content items based on relevance. For example, the disclosed approaches can be used to generate de-biased relevance scores in many different context, e.g., many different types of entity-entity pairs, including user-user pairs (e.g., for connection recommendations), user-company pairs (e.g., for job recommendations), company-company recommendations (e.g., for sales or marketing opportunities), and so on.

In some embodiments, the combined scoring and de-biasing model 106 trains the position-specific bias predictions together with the score predictions (e.g., relevance scores) and stores the position-specific bias predictions as embeddings. For example, the bias prediction embeddings can be stored within the scoring model, e.g., as an embedding table, so that additional storage isn't required (e.g., the embedding store 128 shown in FIG. 1 can be implemented as part of the model 106, itself).

In some implementations, the position-specific bias prediction embeddings are indexed for fast online lookup, e.g., an index 130 is created. For example, at the start of a session (e.g., when a user logs in to application 102), combined scoring and de-biasing model 106 determines one or more contextual characteristics of the user's session (e.g., device type, channel, portal, etc.), uses the index to retrieve the corresponding set of bias prediction embeddings appropriate for the user's then-current computing environment, and uses the retrieved context-specific bias prediction embeddings to de-bias the position-neutral relevance scores.

The embedding store 128 is, for example, a searchable database, lookup table, or tree. The embedding store 128 is indexed for fast online retrieval of bias prediction embeddings. For example, where an embedding identifies a presentation context (e.g., mobile app or browser, or feed or notification inbox) as a bias-inducing element and, for the identified presentation context (or other bias-inducing element), the bias predictions generated by a bias prediction tower of model 106. In the illustrative, nonlimiting example of FIG. 1, the presentation context (or other bias-inducing element) is identified by a three-digit identifier (e.g., 001, 0002, etc.), and, for each context (or other bias-inducing element), each bias prediction (or calibration parameter) is identified as e1, e2, etc. The index 130 maps the context (or other bias-inducing element) identifiers to the corresponding presentation contexts (or other bias-inducing elements).

At inference time, a predictive score (e.g., a relevance score) is input to an isotonic layer of the model 106. The applicable presentation context (or other bias-inducing element) may be determined based on one or more of the user features included in the model input. For example, whether a user is logged in to an application session on a mobile device or a laptop, or whether the user is viewing a feed or an inbox, these and/or other signals can be extracted from the session information recorded by, e.g., an event logging service such as logging service 108. Based on the applicable presentation context (or other bias-inducing element) at inference time, the corresponding bias prediction embedding is retrieved from embedding store 128 using index 130.

The examples shown in FIG. 1 and the accompanying description above are provided for illustration purposes. This disclosure is not limited to the described examples. Additional or alternative details and implementations are described herein.

FIG. 2 is a flow diagram of an example method for training a combined scoring and de-biasing model in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a combined scoring and de-biasing model, including, in some embodiments, components or flows shown in FIG. 2 that may not be specifically shown in other figures and/or including, in some embodiments, components or flows shown in other figures that may not be specifically shown in FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 2, an embodiment of a combined scoring and de-biasing model 200 includes a score prediction tower 204, a bias prediction tower 216, and an isotonic layer 226, where the score prediction tower 204 and the bias prediction tower 216 can be trained at the same time. Tower as used herein may refer to a particular sub-network of a computer-implemented neural network. Each of the score prediction tower 204 and bias prediction tower 216 includes a respective input layer 206, 216, a set of one or more hidden layers 208, 220, and an output layer 210, 222. For example, each of the towers 204, 216 has the same architectural structure.

In some embodiments, each of the layers of each of the towers 204, 216 is fully connected in the sense that the output of each node of each layer is connected to the input of each node of the next subsequent layer, within the respective tower. However, the towers 204, 216 are not connected to each other except via the isotonic layer 226. For example, the final output of the score prediction tower 204 (e.g., the bias inducing element-neutral relevance score P(relevance|user, item) 212) and the final output of the bias prediction tower 216 (e.g., the relevance-neutral bias prediction embedding 224) are both connected (e.g., as inputs) to the isotonic layer 226. The isotonic layer 226 combines the tower-specific final outputs 212, 224 to produce a final, de-biased output (e.g., the de-biased relevance score P(event|relevance, bias-inducing element) 228.

During the training stage, sets of training data including user-item features 202 and bias-inducing elements features 214 are fed into the two model towers, respectively, e.g., score prediction tower 204 receives features 202 and bias-prediction tower 216 receives features 214. The training features 202 include features that are to be input to the score prediction tower 204, e.g., user features (e.g., features associated with users of an online system) and item features (e.g., features associated with content items that may be shared or distributed or accessed via the online system).

In the bias-prediction tower 216, the training features 214, which include the features of the bias-inducing element (e.g., features associated with positions at which the content items may be displayed to the users of the online system), are fed into the bias prediction tower 214. The output from both score prediction tower 202 (e.g., score 212) and the output from the bias-prediction tower 216 (e.g., an array of bias prediction embeddings 224, i.e., an embedding for each position or other bias-inducing element), are fed into the last layer, the isotonic layer 226, to generate the final model prediction score 228.

For a given instance of training data that includes an instance of feature sets 202, 214, respectively (e.g., features 202 associated with users of the online system and corresponding content items that may be shown to those users, and features 214 including position data associated with content items shown to those users), ground-truth labels, which are known to be associated with the combination of features included in the training instance, are combined with score 228 to generate the model prediction errors. A model prediction error is computed by a loss function. A backpropagation algorithm is used to update the model weights in the score prediction tower 204 to reduce the loss function. In this way, the score 212 and the bias prediction embeddings 224 are trained together.

After the score prediction tower 204 and bias prediction tower 214 have been trained with the de-biased scores (e.g., P(event|relevance, bias-inducing element) 228), then, at inference time (also referred to as serving time), the position-neutral relevance score P(relevance|user, item) 212 can be used as the final output and passed to one or more downstream systems, models, processes or components. In other words, after training, the position-neutral relevance score P(relevance|user, item) 212 should be used as the serving score for representing the user-item relevance. Another option for serving is that a fixed bias can be used at serving time. For example, the serving position can be set to zero for all the serving instances and the prediction score 228 from P(event|relevance, position=0) can be used as the final serving score. In this case, since the serving position=0, this score can be considered as a relevance score in position 0, therefore de-bias the positional bias.

In more detail, the bias inducing element-neutral relevance score P(relevance|user, item) 212 indicates a probabilistic likelihood that a particular content item is relevant to a particular user, given a set of user features and a set of content item features (where this set of features does not include position or other bias-inducing element-related features). The relevance-neutral bias prediction embedding 224 encodes the calibration information given a relevance score P(relevance|user, item) and bias inducing elements for certain events. As used herein, bias-inducing element may refer generically to any type of element that induces any type of bias, or more specifically to a specific type of element that induces a specific type of bias. For example, presentation position and aspects of a user's device configuration can be bias-inducing elements. In the case of position bias, the relevance-neutral bias prediction embedding|224 for a position encodes the information for calibration in that particular position. The de-biased relevance score P(event|relevance, bias-inducing element) 228 indicates a probabilistic likelihood of a positive interaction event given both the relevance and the bias-inducing element. In the case of position bias, the de-biased relevance score 228 includes a calibrated version of the bias-inducing element-neutral relevance score 212, which takes the presentation position (or other bias-inducing element) into account. For example, assuming a position-neutral relevance score computed based on user features and content item features is 0.6. Supposing that this content will be presented at a position 2, an embedding of position=2 will be generated such as [0.9, 0.8, 0.9, . . . ], etc. The isotonic layer will combine the relevance score 0.6 and position 2's embedding to generate a final score, such as 0.5. For different positions, the position embedding should be different. For example, position 1's embedding could be [1.0, 0.9, 0.9, . . . ], etc. And if P(relevance|user, item)=0.6 and position 1's embedding are input into the isotonic layer, a different final score, such as 0.55, will be generated.

During training, the towers 204, 216 can be trained at the same time (or co-trained) by using different features of the same training instance, as described above. Deep learning models are trained with large amounts of training data. Constraints of the computing environment (e.g., device or processor architecture or capabilities) and/or the model itself can limit size of the training set such that the model training involves successively applying the model to smaller batches of training data.

In FIG. 2, the training data to which the score prediction tower 204 is applied includes n training batches, where n is a positive integer, each training batch includes a number of training examples, and each training example includes user features, item features 202, bias-inducing elements features 214 and ground-truth event labels.

The user-item features are fed into the relevance tower's input layer as batches of input, e.g., as 202a, 202b, 202n, etc., and, at the same time, the bias-inducing elements features are fed to the input layer of the bias prediction tower 216 as n training feature batches, e.g., 214a, 214b, 214n, where n is a positive integer, each training batch includes a number of training examples, and each training example contains user-item features 202 and bias-inducing elements features (which could include presentation position feature and context feature, etc.) 214. For example, the training bias-inducing elements features 214 used to train the bias prediction tower 216 include or are based on representative historical interactions with content items via a presentation mechanism of an online application. The context identifier indicates a particular presentation context, such as a particular computing environment, e.g., mobile device or web browser. This is because different presentation contexts can have different numbers of available presentation positions. For example, a web browser presentation context may have a greater number of presentation positions available than a mobile device context.

In supervised machine learning, as shown in FIG. 2, each training example includes 202, 214 and an event label associated with the corresponding user-item features 202 and context-bias inducing elements features 214. The event label includes a ground truth indication of whether or not an event occurred in connection with the corresponding user-item features and bias-inducing element (e.g., presentation position) with respect to the corresponding presentation context. The event label (e.g., 0 or 1) is used as a supervised signal to train the model. For example, the bias-inducing element is, in the case of position bias, presentation position, and the event labels are indications of whether or not an event occurred at the corresponding presentation position, e.g., the event label has a value of 0 if an event did not occur and a value of 1 if an event occurred. For instance, a training example is composed of features 202, 214 and label could take the form of [user, item], [mobile, 1] and [0], where “mobile” refers to the presentation context, 1 refers to the presentation position, and 0 indicates that an event did not occur at that position in that example. Another training example 202, 214 could take the form of [user, item] [browser, 2] and [1], where “browser” indicates the presentation context, 2 indicates the presentation position, and 1 indicates that an event occurred at that position in that example. The training data feature batches [202a, 214a, labels_a], [202b, 214b, labels_b], [202n, 214n, labels_n] include many such training examples collected over time as users interact with the associated presentation mechanism of the application. These training examples can be aggregated to create a distribution of event data across the available presentation positions for each available presentation context.

Score prediction tower 204 and bias prediction tower 216 are co-trained by recursively feeding feature batches 202 to relevance score prediction tower 204 while concurrently feeding feature batch 214 to bias prediction tower 216, up to and including the n training batches.

During training, each training batch is received by the respective input layer 206, 218. The batches of training data are successively processed by the respective one or more hidden layers 208, 220 in a feedforward manner to the respective output layers 210, 222, and finally to isotonic layer 226 and model output 228. During tower training respective errors are computed on the respective final outputs 228, 224, isotonic layer 226 and final output result 228. and backpropagated (adjusting weights or parameters) through the model output 228, isotonic layer 226, respective hidden layers 208, 220 to the respective input layers 204, 216.

During training, the final outputs 212, 224 are input to the isotonic layer 226. As described in more detail below with reference to FIG. 4, the isotonic layer 226 applies an isotonic regression technique that has been adapted for use with deep learning models to the outputs 212, 224 and outputs the de-biased relevance score 228. As described above, in the position bias example, the de-biased relevance score 228 is a calibrated score for relevance score 226 by using the bias inducing elements (position in this particular case) and isotonic layer. An error computed based on the bias-neutral relevance score 212 and the de-biased relevance score 228 may be backpropagated through the relevance score prediction tower 204, meanwhile, the error generated by de-biased relevance score 228 also may be backpropagated through the bias prediction tower 216 in a similar way.

As described above, the isotonic layer 226 takes both the relevance score 212 and the bias prediction embedding 224 as input to generate a de-biased (or calibrated) version of the relevance score 228 for each bias-inducing element (e.g., each presentation position). The described approach eliminates the need to compute additional propensity scores and seamlessly integrates with deep learning frameworks. Unlike prior approaches, using the described approaches, co-training with another model to train a propensity score is not required.

Rather, the described approaches achieve de-biasing by training the de-biased relevance score, e.g., P(event|relevance, bias-inducing element) 228 and the original relevance score P(relevance|user, item) 212 in different parts of the model. The original relevance score P(relevance|user, item) 212 does not rely on any information about the bias-inducing element (e.g., information about presentation position), since the bias (e.g., positional bias) is accounted for by P(event|relevance, bias-inducing element) 228, e.g., P(event|relevance, position).

The described approach provides a versatile de-biasing framework. For instance, where position bias is considered to be dependent upon the device used (e.g., mobile vs. desktop or laptop), the described approach can be used to create a de-bias embedding by inputting the de-bias features (e.g., device, position) into the de-bias network (e.g., the bias prediction tower 216). This would generate a final de-bias embedding (e.g., final output 224) to be used as input to the isotonic layer 226.

The examples shown in FIG. 2 and the accompanying description, above are provided for illustration purposes. This disclosure is not limited to the described examples. Additional or alternative details and implementations are described herein.

FIG. 3 is a flow diagram of an example method for generating predictions using a combined scoring and de-biasing model in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a combined scoring and de-biasing model, including, in some embodiments, components or flows shown in FIG. 3 that may not be specifically shown in other figures and/or including, in some embodiments, components or flows shown in other figures that may not be specifically shown in FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 3, a trained version of a combined scoring and de-biasing model 300 is shown in operation, e.g., at inference (or serving) time. In FIG. 3, the combined scoring and de-biasing model 300 is a deep neural network model that includes a score prediction tower 304, a bias prediction tower 316, and an isotonic layer 326. The core prediction tower 304, bias prediction tower 316, and isotonic layer 326 have the same or similar architecture as described above with reference to FIG. 2 and are trained in the same or similar manner as described above with reference to FIG. 2.

At inference time, an unlabeled user-item feature set (e.g., [user features, item features]) 302 is input to the trained score prediction tower 304 at an input layer 306 and successively processed by one or more hidden layers 308 to produce a final output (e.g., relevance score P(relevance|user, item) 312 at output layer 310. The user-item feature set 302 is unlabeled because the corresponding score is unknown and will be predicted by the model 300.

At the same time or prior to inference time, bias prediction tower 316 receives an unlabeled set of features relating to a bias-inducing element (e.g., [context, position features]) 314. The feature set 314 is unlabeled in the sense that at least some information about the bias-inducing element is unknown. For instance, using the example of position bias, when ranking content items, the position at which a content item will be presented to the user is unknown. In fact, one of the objectives of the model 300 is to produce a relevance score for a content item, where the relevance score is not impacted by position bias. Since this aspect of the bias-inducing element information is unknown at serving time, dummy values or default values can be used as substitutes for the actual bias-inducing element information. For example, in the case of position bias, a default or random position value (such as zero, or five, or any position value) is inserted into the position features at serving time. This is in contrast to the training stage, where the position information is known because historical position data is used to train the bias prediction tower 316. Using a default value for the position (or other bias-inducing element) allows the position bias to be corrected because every ranking uses the same default value.

As described, the combined scoring and debiasing model is not limited to position bias but can be adapted to other bias-inducing elements. For example, the user's electronic device type (e.g., desktop or smartphone, etc.) can be treated as a bias-inducing element in a similar manner. For instance, the user's electronic device type can be obtained at or prior to the serving time and used as input to the bias prediction tower 314 to perform the corresponding debiasing for the device type.

The features 314 are input to the trained bias prediction tower 316 at an input layer and successively processed by one or more hidden layers to produce a final output (e.g., a bias prediction at an output layer of the bias prediction tower. In the position bias example, the bias predictions produced by the bias prediction tower 316 are vectors having dimensions that contain bias predictions (or calibration parameters) for presentation positions. These bias prediction vectors can be stored as embeddings, e.g., in the embedding store 128. The embedding space used to determine the bias prediction embeddings is defined by the model training process, e.g., the training process described above with reference to FIG. 2.

In the simplest case, the bias prediction tower 316 can be an embedding look-up table. For example, if position is the only type of bias for which the relevance score is to be calibrated, then the bias prediction tower 316 is a simple embedding data store 128 (e.g., a key, value store with the key being the position index and the value being the positional bias prediction embedding). However, as shown in FIG. 3, the bias prediction tower 316 can be configured to accommodate more than one type of bias as the input. In these cases, the bias prediction tower 316 includes the neural networks as described, which takes the input features and generates the final bias prediction embeddings 324.

At inference time, isotonic layer 326 may combine the relevance score 312 with the applicable bias prediction embedding 324 to produce and output a de-biased relevance score (e.g., P(event|relevance, bias-inducing element) 328. The de-biased relevance score 328 is made available for use by one or more applications, processes, services, models, components, systems, or devices. For example, the de-biased relevance score 328 is provided to or made accessible to one or more recommendation systems (e.g., recommendation system 104) via, e.g., an application programming interface or other communication mechanism.

Embedding as used herein may refer to a numerical representation of data. The embedding may encode information relative to an embedding space. Embeddings and embedding spaces can be generated by artificial intelligence (AI) models. An embedding can be expressed as a vector, where each dimension of the vector includes a numerical value that can be an integer or a real number. The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some implementations, train as used herein refers to an iterative process of applying an AI algorithm to one or more sets of training data, analyzing the output of the AI model in comparison to expected model output using a loss function (also referred to as a cost function or error function), adjusting one or more parameters and/or coefficients of the AI model, and repeating the process until the difference between the actual model output and the expected model output falls within an acceptable amount of error or tolerance.

The examples shown in FIG. 3 and the accompanying description, above are provided for illustration purposes. This disclosure is not limited to the described examples. Additional or alternative details and implementations are described herein.

FIG. 4 illustrates an example of an isotonic function in accordance with some embodiments of the present disclosure. The disclosed approaches create a modified version of the isotonic function that is adapted for use within a deep neural network as described above.

In FIG. 4, the isotonic function is represented as a simulated step function in which the x axis indicate a raw score, e.g., a raw, uncalibrated relevance score, and the y axis represents the calibrated version of the raw score. The data points y0, y1, etc. represent the calibrated scores for the corresponding raw scores on the x axis. For a given raw score assigned to a bucket i, the calibrated score yi is a sum function of b, and ReLU(wj)Δx) for all j<=i, where b is a learnable parameter (machine learned based on the training data), Δx is the step size (here, 0.2), and wi is a learnable weight machine learned based on the training data).

In more detail, the raw, uncalibrated score is divided into buckets with step size=Δx. For example, a raw score falling into a bucket i is calibrated to a calibrated score yi. In this way, a higher raw score may fall into more buckets than a lower raw score, depending on the step size. Conversely, a lower raw score may fall into fewer buckets than a higher raw score, depending on the step size. The step size Δx and number of learnable parameters are configurable according to the requirements of a particular design or implementation. For example, a smaller step size Δx produces a smoother calibration curve and more learnable parameters. When the step size Δx approaches zero, an arbitrary isotonic function y=f(x) can be generated.

In prior approaches, isotonic regression was not thought to be compatible with deep learning models the need for deep learning models to be trained in batches conflicts with the need for isotonic regression to have a complete, entire dataset (e.g., to compute accurate statistics). However, the modified isotonic regression described is adapted to the deep learning framework because it can be added as a final layer that is co-trained along with the scoring model as described above.

The examples shown in FIG. 4 and the accompanying description, above are provided for illustration purposes. This disclosure is not limited to the described examples. Additional or alternative details and implementations are described herein.

FIG. 5 illustrates example deep learning implementations of an isotonic function in accordance with some embodiments of the present disclosure. Isotonic regression may refer to the technique of fitting a free-form line to a sequence of observations such that the fitted line is non-decreasing (or non-increasing) everywhere, and lies as close to the observations as possible.

In some embodiments, isotonic regression is simulated by adapting piecewise fitting for deep learning by machine learning the fitting parameters. Piecewise fitting involves dividing the space for input into different segments (or buckets), such that within each segment (or bucket), a different weight is used to do the fitting. In the example of FIG. 5, y=w0*(x1−x0)+w1*(x2−x1)+w2*(x−x2), where y is the output, each x is an input (or portion of an input) assigned to a particular segment (or bucket), and each w is a weight associated with a particular segment or bucket. The weight for each segment (e.g., w0, w1, w2, w3, etc.) is learned through the deep learning training process.

In some embodiments, isotonic regression is simulated by adapting a weight-activation dot product for deep learning. In these embodiments, the weight-activation dot product is a dot product computed between a weight vector and an input activation vector. The isotonic property can be achieved by setting all weights to non-negative values. Further, if the weight vector is treated as an embedding, the embedding can be trained based on different features. In the position bias example, if presentation position is used as the input feature, then the output is a trained position embedding that includes a bias prediction (or calibration parameter) for each different position.

FIG. 6 is a block diagram of a computing system that includes a combined scoring and de-biasing model in accordance with some embodiments of the present disclosure.

In the embodiment of FIG. 6, a computing system 600 includes one or more user systems 610, a network 620, an application system 630, a recommendation system 650, a combined scoring and de-biasing model 680, a data storage system 660, an event logging service 670, and a query service 690. Embodiments of combined scoring and de-biasing model 680 include components shown in and described herein, for example components of one or more of FIG. 1, FIG. 2, FIG. 3, FIG. 4, or FIG. 5. Combined scoring and de-biasing model 680 includes one or more artificial intelligence-based models, such as discriminative and/or generative models, neural networks and/or other types of machine learning-based models, probabilistic models, statistical models, transformer-based models, and/or any combination of any of the foregoing. Combined scoring and de-biasing model 680 enables access to these models, for example by providing an application programming interface (API) and/or other communication mechanisms. Combined scoring and de-biasing model 680 can include automated or semi-automated machine learning-based training and model validation services. Combined scoring and de-biasing model 680 can include a monitoring service that periodically generates, publishes, or broadcasts latency and/or other performance metrics associated with the models. For example, combined scoring and de-biasing model 680 can provide a set of APIs that can be used to obtain performance metrics for the combined scoring and de-biasing model 680.

All or at least some components of combined scoring and de-biasing model 680 are implemented at the user system 610, in some implementations. For example, portions of combined scoring and de-biasing model 680 are implemented directly upon a single client device such that communications involving applications running on user system 610 and combined scoring and de-biasing model 680 occur on-device without the need to communicate with, e.g., one or more servers, over the Internet. Dashed lines are used in FIG. 6 to indicate that all or portions of combined scoring and de-biasing model 680 can be implemented directly on the user system 610, e.g., the user's client device. In other words, both user system 610 and combined scoring and de-biasing model 680 can be implemented on the same computing device, in some implementations. In other implementations, all or portions of combined scoring and de-biasing model 680 are implemented on one or more servers and in communication with user systems 610 via network 620. Components of the computing system 600 including the combined scoring and de-biasing model 680 are described in more detail herein.

A user system 610 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 610 can be connected to network 620 at the same time or at different times. Different user systems 610 can contain similar components as described in connection with the illustrated user system 610. For example, many different end users of computing system 600 can be interacting with many different instances of application system 630 through their respective user systems 610, at the same time or at different times.

User system 610 includes a user interface 612. User interface 612 is installed on user system 610 or accessible to user system 610 via network 620. Embodiments of user interface 612 include a front end portion of application system 630, e.g., presentation mechanism 114.

User interface 612 includes, for example, a graphical display screen that includes graphical user interface elements such as at least one input box or other input mechanism and at least one slot (also referred to as a position or card). A slot as used herein refers to a space or location on a graphical display such as a web page or mobile device screen, into which digital content such as documents, search results, feed items, chat boxes, or threads, can be loaded for display to the user. For example, user interface 612 may be configured with a scrollable arrangement of variable-length slots that simulates an online chat or instant messaging session and/or a scrollable arrangement of slots that contain search results, such as a news feed. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

User interface 612 can be used to interact with one or more application systems 630. For example, user interface 612 enables the user of a user system 610 to browse a feed, notification list, or search results, or to create, edit, send, view, receive, process, and organize search queries, search results, content items, and/or portions of online dialogs. In some implementations, user interface 612 enables the user to input requests (e.g., queries) for various different types of information, to initiate user interface events, and to view or otherwise perceive output such as data and/or digital content produced by, e.g., an application system 630 or combined scoring and de-biasing model 680. For example, user interface 612 can include a graphical user interface (GUI), a conversational voice/speech interface, a virtual reality, augmented reality, or mixed reality interface, and/or a haptic interface. User interface 612 includes a mechanism for entering search queries and/or selecting search criteria (e.g., facets, filters, etc.), selecting GUI user input control elements, and interacting with digital content such as search results, entity profiles, posts, articles, feeds, and online dialogs. Examples of user interface 612 include web browsers, command line interfaces, and mobile app front ends. User interface 612 as used herein can include application programming interfaces (APIs).

Network 620 includes an electronic communications network. Network 620 can be implemented on any medium or mechanism that provides for the exchange of digital data, signals, and/or instructions between the various components of computing system 600. Examples of network 620 include, without limitation, a Local Area Network (LAN), a Wide Area Network (WAN), an Ethernet network or the Internet, or at least one terrestrial, satellite or wireless link, or a combination of any number of different networks and/or communication links.

Application system 630 can include, for example, one or more online systems that provide social media services, general-purpose search engines, specific-purpose search engines, messaging systems, content distribution platforms, e-commerce software, enterprise software, or any combination of any of the foregoing or other types of software. Application system 630 includes any type of application system that provides or enables the retrieval of and interactions with at least one form of digital content, including machine-generated content, via user interface 612. In some implementations, portions of combined scoring and de-biasing model 680 are components of application system 630.

In some implementations, a front end portion of application system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP request over network 620 in response to user input that is received through a user interface provided by the web application, mobile app, or web browser, such as user interface 612. A server running application system 630 can receive the input from the web application, mobile app, or browser executing user interface 612, perform at least one operation using the input, and return output to the user interface 612 using a network communication such as an HTTP response, which the web application, mobile app, or browser receives and processes at the user system 610.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some implementations, content distribution service 638 is part of application system 630. In other implementations, content distribution service 638 interfaces with application system 630 and/or combined scoring and de-biasing model 680, for example, via one or more application programming interfaces (APIs).

Recommendation system 650 includes one or more item scoring, ranking, sorting, filtering and/or selection functions. For example, recommendation system 650 ranks content items or entities based on the de-biased scores output by combined scoring and de-biasing model 680 and then selects the top k items or entities for presentation based on the de-biased scores, where k is a positive integer that is configurable according to the requirements of a particular design or implementation.

Event logging service 670 captures and records network activity data generated during operation of application system 630, including user interface events generated at user systems 610 via user interface 612 (e.g., via presentation mechanism 114), in real time, and formulates the user interface events and/or other network activity data into a data stream that can be consumed by, for example, a stream processing system. Examples of network activity data include views of content items, logins, page loads, input of search queries or query terms, selections of facets or filters, clicks on search results or graphical user interface control elements, scrolling lists of search results, and social action data such as likes, shares, comments, and social reactions (e.g., “insightful,” “curious,” etc.). For instance, when a user of application system 630 via a user system 610 enters input or clicks on a user interface element, such as a content item in a feed, or selects a user interface control element such as a view, comment, share, or reaction button, or uploads a file, or inputs a query, or scrolls through a feed, etc., event logging service 670 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to a display of content, such as a list of recommendations or feed items, event logging service 670 stores the corresponding event data in a log. Event logging service 670 generates a data stream that includes a record of real-time event data for each user interface event that has occurred. Event data logged by event logging service 670 can be pre-processed and anonymized as needed so that it can be used as context data to, for example, configure one or more instructions for one or more artificial intelligence models (e.g., deep learning models), or to modify weights, scores, and/or parameters associated with the combined scoring and de-biasing model.

Query service 690 includes an information retrieval system that formulates and executes queries on information stored in one or more data stores, to identify and retrieve information related to one or more search criteria. For example, query service 690 executes searches against one or more user data stores to obtain user features associated with particular users and executes searches against one or more content item data stores to obtain item features associated with particular content items.

Data storage system 660 includes data stores and/or data services that store digital data received, used, manipulated, and produced by application system 630 and/or combined scoring and de-biasing model 680, including user inputs, model outputs, weights, parameters, and embeddings.

In the example of FIG. 6, data storage system 660 includes a training data store 662, an embedding data store 664, a user data store 666, and a content data store 668. Training data store 662 stores data that can be used to train one or more portions of the combined scoring and de-biasing model 680. Embedding data store 664 stores embeddings such as bias prediction embeddings. User data store 666 stores user features such as user profile data, user preferences, and/or user activity data. Content data store 668 stores digital content items and/or features of digital content items. While shown in FIG. 6 as components of a data storage system 660, all or portions of each or any of training data store 662, embedding data store 664, user data store 666, and/or content data store 668 are implemented on the user system 610 in some embodiments. For example, a data store can include a volatile memory such as a form of random access memory (RAM) available on user system 610 for storing state data generated at the user system 610 or an application system 630. As another example, in some implementations, a separate, personalized version of each or any of the training data store 662, embedding data store 664, user data store 666, and/or content data store 668 is created for each user such that data is not shared between or among the separate, personalized versions of the data stores.

In some embodiments, data storage system 660 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 660 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 660 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 660 can be part of computing system 600 or accessed by computing system 600 over a network, such as network 620.

While not specifically shown, it should be understood that any of user system 610, application system 630, combined scoring and de-biasing model 680, recommendation system 650, data storage system 660, event logging service 670, and query service 690 includes an interface embodied as computer programming code stored in computer memory that when executed causes a computing device to enable bidirectional communication with any other of user system 610, application system 630, combined scoring and de-biasing model 680, recommendation system 650, data storage system 660, event logging service 670, and query service 690 using a communicative coupling mechanism. Examples of communicative coupling mechanisms include network interfaces, inter-process communication (IPC) interfaces and application program interfaces (APIs).

Each of user system 610, application system 630, combined scoring and de-biasing model 680, recommendation system 650, data storage system 660, event logging service 670, and query service 690 is implemented using at least one computing device that is communicatively coupled to electronic communications network 620. Any of user system 610, application system 630, combined scoring and de-biasing model 680, recommendation system 650, data storage system 660, event logging service 670, and query service 690 can be bidirectionally communicatively coupled by network 620. User system 610 as well as other different user systems (not shown) can be bidirectionally communicatively coupled to application system 630 and/or combined scoring and de-biasing model 680.

A typical user of user system 610 can be an administrator or end user of application system 630 or combined scoring and de-biasing model 680. User system 610 is configured to communicate bidirectionally with any of user system 610, application system 630, combined scoring and de-biasing model 680, recommendation system 650, data storage system 660, event logging service 670, and query service 690 over network 620.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application system 630, combined scoring and de-biasing model 680, recommendation system 650, data storage system 660, event logging service 670, and query service 690 are implemented using computer software, hardware, or software and hardware, and can include combinations of automated functionality, data structures, and digital data, which are represented schematically in the figures. User system 610, application system 630, combined scoring and de-biasing model 680, recommendation system 650, data storage system 660, event logging service 670, and query service 690 are shown as separate elements in FIG. 6 for case of discussion but, except as otherwise described, the illustration is not meant to imply that separation of these elements is required. The illustrated systems, services, and data stores (or their functionality) of each of user system 610, application system 630, combined scoring and de-biasing model 680, recommendation system 650, data storage system 660, event logging service 670, and query service 690 can be divided over any number of physical systems, including a single physical computer system, and can communicate with each other in any appropriate manner.

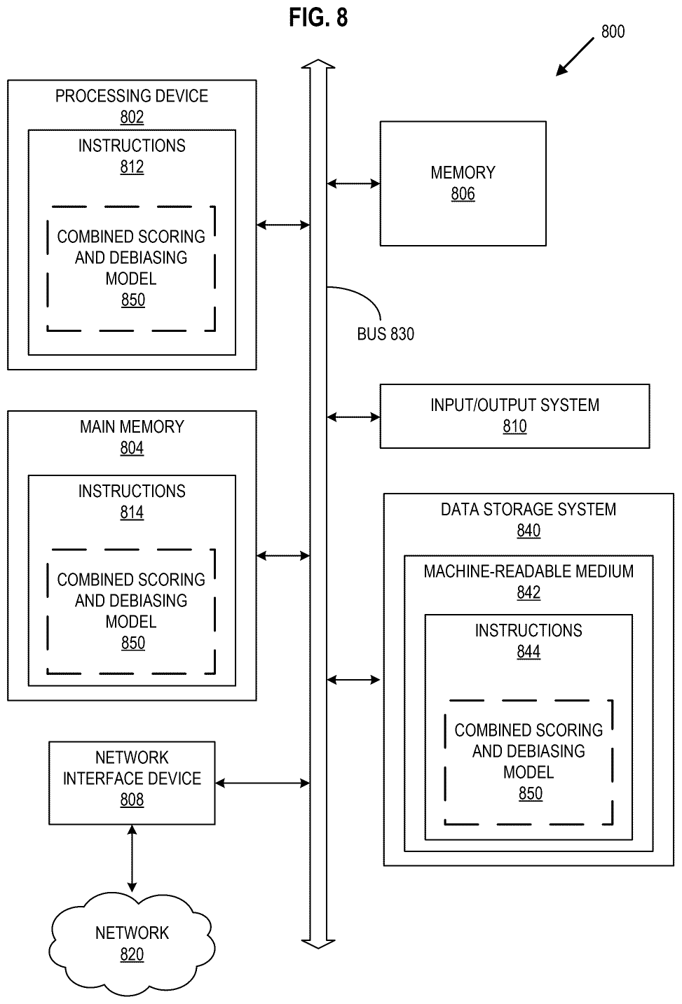

In the embodiment of FIG. 8, portions of combined scoring and de-biasing model 680 that may be implemented on a front end system, such as one or more user systems, and portions of combined scoring and de-biasing model 680 that may be implemented on a back end system such as one or more servers, are collectively represented as combined scoring and de-biasing model 850 for case of discussion only. For example, portions of combined scoring and de-biasing model 680 are not required to be implemented all on the same computing device, in the same memory, or loaded into the same memory at the same time. For instance, access to portions of combined scoring and de-biasing model 680 can be limited to different, mutually exclusive sets of user systems and/or servers. For instance, in some implementations, a separate, personalized version of combined scoring and de-biasing model 680 is created for each user of the combined scoring and de-biasing model 680 such that data is not shared between or among the separate, personalized versions of the combined scoring and de-biasing model 680. Additionally, certain portions of combined scoring and de-biasing model 680 typically may be implemented on user systems while other portions of combined scoring and de-biasing model 680 typically may be implemented on a server computer or group of servers. In some embodiments, however, one or more portions of combined scoring and de-biasing model 680 are implemented on user systems. For example, combined scoring and de-biasing model 680 is entirely implemented on user systems, e.g., client devices, in some implementations. For instance, a version of combined scoring and de-biasing model 680 can be embedded in a client device's operating system or stored at the client device and loaded into memory at execution time. Further details with regard to the operations of combined scoring and de-biasing model 850 are described herein.

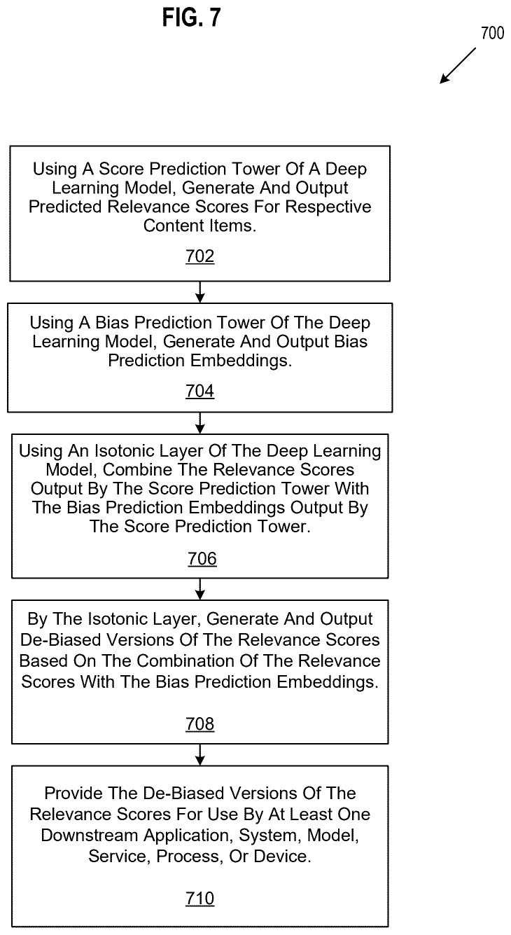

FIG. 7 is a flow diagram of an example method for generating predictions using a combined scoring and de-biasing model in accordance with some embodiments of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by one or more components of a combined scoring and de-biasing model such as the combined scoring and de-biasing model 680 of FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 702, the processing device uses a score prediction tower of a deep learning model to generate and output predicted relevance scores for respective content items. Examples of deep learning models with score prediction towers are described above with reference to FIG. 1, FIG. 2, and FIG. 3. In some implementations, the score prediction tower generates the predicted relevance scores independently of the bias prediction tower of the deep learning model.

At operation 704, the processing device uses a bias prediction tower of the deep learning model to generate and output bias prediction embeddings. Examples of deep learning models with bias prediction towers and score prediction towers are described above with reference to FIG. 1, FIG. 2, and FIG. 3. In some implementations, the bias prediction tower generates the bias prediction embeddings independently of the scoring tower.

At operation 706, the processing device uses an isotonic layer of the deep learning model to combine the relevance scores output by the score prediction tower with the bias prediction embeddings output by the score prediction tower. Examples of deep learning models with score prediction towers, bias prediction towers, and isotonic layers are described above with reference to FIG. 1, FIG. 2, and FIG. 3. In some implementations, the bias prediction embeddings are representative of historical interactions with content items via a presentation mechanism of an online application (e.g., a feed) that includes a plurality of bias-inducing elements (e.g., presentation positions). In some implementations, the isotonic layer of the deep learning model connects an output layer of the score prediction tower with an output layer of the bias prediction tower.

At operation 708, the processing device uses the isotonic layer to generate and output de-biased versions of the relevance scores based on the combination of the relevance scores with the bias prediction embeddings.

In some implementations, to generate the de-biased versions of the relevance scores, the isotonic layer simulates a step function. In some implementations, to simulate a step function, the isotonic layer applies a dot activation mechanism to the relevance scores. In some implementations, to simulate a step function, the isotonic layer applies a modified piecewise fitting mechanism to the relevance scores.

At operation 710, the processing device provides the de-biased versions of the relevance scores for use by at least one downstream application, system, model, service, process, or device. Examples of downstream applications include recommendation systems such as content item recommendation systems, connection recommendation systems, job recommendation systems, and other kinds of entity recommendation systems. In some implementations, the processing device provides the de-biased versions of the relevance scores for use by a presentation mechanism of an application to configure the presentation of the content items with the bias-inducing elements in accordance with the de-biased versions of the relevance scores. For example, the de-biased versions of the relevance scores are used to assign content items to slots, positions, or cards of a presentation mechanism.

In some implementations, during training of the deep learning model, output of the isotonic layer is used in backpropagation of the score prediction tower and not used in backpropagation of the bias prediction tower. In some implementations, during training of the deep learning model, the score prediction tower and the bias prediction tower are co-trained on different training data. In some implementations, the score prediction tower is trained using position-neutral training data and the bias prediction tower is trained using relevance-neutral training data.

The examples shown in FIG. 7 and the accompanying description, above are provided for illustration purposes. This disclosure is not limited to the described examples.

FIG. 8 is a block diagram of an example computer system including components of a combined scoring and de-biasing model in accordance with some embodiments of the present disclosure.

In FIG. 8, an example machine of a computer system 800 is shown, within which a set of instructions for causing the machine to perform any of the methodologies discussed herein can be executed. In some embodiments, the computer system 800 can correspond to a component of a networked computer system (e.g., as a component of the computing system 100 of FIG. 1 or the computer system 600 of FIG. 6) that includes, is coupled to, or utilizes a machine to execute an operating system to perform operations corresponding to one or more components of the combined scoring and de-biasing model of FIG. 1 or the combined scoring and de-biasing model 680 of FIG. 6. For example, computer system 800 corresponds to a portion of computing system 600 when the computing system is executing a portion of combined scoring and de-biasing model or combined scoring and de-biasing model 680.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some embodiments of FIG. 8, combined scoring and de-biasing model 850 represents portions of combined scoring and de-biasing model 680 while the computer system 800 is executing those portions of combined scoring and de-biasing model 680. Instructions 812 include portions of combined scoring and de-biasing model 850 when those portions of the combined scoring and de-biasing model 850 are being executed by processing device 802. Thus, the combined scoring and de-biasing model 850 is shown in dashed lines as part of instructions 812 to illustrate that, at times, portions of the combined scoring and de-biasing model 850 are executed by processing device 802. For example, when at least some portion of the combined scoring and de-biasing model 850 is embodied in instructions to cause processing device 802 to perform the method(s) described herein, some of those instructions can be read into processing device 802 (e.g., into an internal cache or other memory) from main memory 804 and/or data storage system 840. However, it is not required that all of the combined scoring and de-biasing model 850 be included in instructions 812 at the same time and portions of the combined scoring and de-biasing model 850 are stored in at least one other component of computer system 800 at other times, e.g., when at least one portion of the combined scoring and de-biasing model 850 are not being executed by processing device 802.

The computer system 800 further includes a network interface device 808 to communicate over the network 820. Network interface device 808 provides a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, haptic information, and/or digital imagery, for example.

The data storage system 840 includes a machine-readable storage medium 842 (also known as a computer-readable medium) on which is stored at least one set of instructions 844 or software embodying any of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media. In one embodiment, the instructions 844 include instructions to implement functionality corresponding to a combined scoring and de-biasing model 850 (e.g., the combined scoring and de-biasing model 106 of FIG. 1 or combined scoring and de-biasing model 680 of FIG. 6).

Dashed lines are used in FIG. 8 to indicate that it is not required that the combined scoring and de-biasing model be embodied entirely in instructions 812, 814, and 844 at the same time. In one example, portions of the combined scoring and de-biasing model are embodied in instructions 814, which are read into main memory 804 as instructions 814, and portions of instructions 812 are read into processing device 802 as instructions 812 for execution. In another example, some portions of the combined scoring and de-biasing model are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 8 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 600, can carry out the above-described computer-implemented methods in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different Al platforms that provide different functionalities.

According to the techniques described herein, users may have full control over the level of access to their personal data that is shared with other parties. According to the techniques described herein, personal data provided by users may be processed to determine prompts when using a generative AI feature at the request of the user, but not to train generative Al models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with Al in all products and AI systems. In some embodiments, notices may be provided to users when AI tools are being used to provide features.

Illustrative examples of the technologies disclosed herein are provided below. An embodiment of the technologies may include any of the examples described herein, or any combination of any of the examples described herein, or any combination of any portions of the examples described herein.

In some aspects, the techniques described herein relate to a method including: using a score prediction tower of a deep learning model to generate and output predicted relevance scores for respective content items; using a bias prediction tower of the deep learning model to generate and output bias prediction embeddings; using an isotonic layer of the deep learning model to combine the relevance scores output by the score prediction tower with the bias prediction embeddings output by the score prediction tower; by the isotonic layer, generating and outputting de-biased versions of the relevance scores based on the combination of the relevance scores with the bias prediction embeddings; and providing the de-biased versions of the relevance scores for use by at least one application, system, model, service, process, or device.

In some aspects, the techniques described herein relate to a method, wherein to generate the de-biased versions of the relevance scores, the isotonic layer simulates a step function.

In some aspects, the techniques described herein relate to a method, wherein to simulate the step function, the isotonic layer applies a dot activation mechanism to the relevance scores.

In some aspects, the techniques described herein relate to a method, wherein to simulate a step function, the isotonic layer applies a modified piecewise fitting mechanism to the relevance scores.

In some aspects, the techniques described herein relate to a method, wherein during training of the deep learning model, output of the isotonic layer is used in backpropagation of the score prediction tower and not used in backpropagation of the bias prediction tower.

In some aspects, the techniques described herein relate to a method, wherein during training of the deep learning model, the score prediction tower and the bias prediction tower are co-trained on same or different training data.

In some aspects, the techniques described herein relate to a method, wherein the score prediction tower is trained using position-neutral training data and the bias prediction tower is trained using relevance-neutral training data.

In some aspects, the techniques described herein relate to a method, wherein the bias prediction embeddings are representative of historical interactions with content items via a presentation mechanism of an online application that includes a plurality of bias-inducing elements.

In some aspects, the techniques described herein relate to a method, wherein the isotonic layer of the deep learning model connects an output layer of the score prediction tower with an output layer of the bias prediction tower.

In some aspects, the techniques described herein relate to a method, wherein the score prediction tower generates the predicted relevance scores independently of the bias prediction tower of the deep learning model.

In some aspects, the techniques described herein relate to a method, wherein the bias prediction tower generates the bias prediction embeddings independently of the scoring tower.

In some aspects, the techniques described herein relate to a method, further including providing the de-biased versions of the relevance scores for use by a presentation mechanism to configure the presentation of the content items with a plurality of bias-inducing elements in accordance with the de-biased versions of the relevance scores.

In some aspects, the techniques described herein relate to a system including: at least one processor; and at least one memory coupled to the at least one processor, wherein the at least one memory includes at least one instruction that, when executed by the at least one processor, cause the at least one processor to perform at least one operation including: using a score prediction tower of a deep learning model to generate and output predicted relevance scores for respective content items; using a bias prediction tower of the deep learning model to generate and output bias prediction embeddings; using an isotonic layer of the deep learning model to combine the relevance scores output by the score prediction tower with the bias prediction embeddings output by the score prediction tower; by the isotonic layer, generating and outputting de-biased versions of the relevance scores based on the combination of the relevance scores with the bias prediction embeddings; and providing the de-biased versions of the relevance scores for use by at least one application, system, model, service, process, or device.

In some aspects, the techniques described herein relate to a system, wherein to generate the de-biased versions of the relevance scores, the isotonic layer simulates a step function; and wherein to simulate the step function, the isotonic layer at least one of applies a dot activation mechanism to the relevance scores or applies a modified piecewise fitting mechanism to the relevance scores.

In some aspects, the techniques described herein relate to a system, wherein at least one of during training of the deep learning model, output of the isotonic layer is used in backpropagation of the score prediction tower and the output of the isotonic layer not used in backpropagation of the bias prediction tower, or the score prediction tower and the bias prediction tower are co-trained on same or different training data, wherein the score prediction tower is trained using position-neutral training data and the bias prediction tower is trained using relevance-neutral training data.

In some aspects, the techniques described herein relate to a system, wherein the isotonic layer of the deep learning model connects an output layer of the score prediction tower with an output layer of the bias prediction tower.

In some aspects, the techniques described herein relate to a system, wherein at least one of the score prediction tower generates the predicted relevance scores independently of the bias prediction tower of the deep learning model, or the bias prediction tower generates the bias prediction embeddings independently of the scoring tower.

In some aspects, the techniques described herein relate to at least one non-transitory machine-readable storage medium including at least one instruction that, when executed by at least one processor, causes the at least one processor to perform at least one operation including: using a score prediction tower of a deep learning model to generate and output predicted relevance scores for respective content items; using a bias prediction tower of the deep learning model to generate and output bias prediction embeddings; using an isotonic layer of the deep learning model to combine the relevance scores output by the score prediction tower with the bias prediction embeddings output by the score prediction tower; by the isotonic layer, generating and outputting de-biased versions of the relevance scores based on the combination of the relevance scores with the bias prediction embeddings; and providing the de-biased versions of the relevance scores for use by at least one application, system, model, service, process, or device.

In some aspects, the techniques described herein relate to an at least one non-transitory machine-readable storage medium, wherein to generate the de-biased versions of the relevance scores, the isotonic layer simulates a step function, and to simulate the step function, the isotonic layer applies a modified piecewise fitting mechanism to the relevance scores.

In some aspects, the techniques described herein relate to an at least one non-transitory machine-readable storage medium, wherein the isotonic layer of the deep learning model connects an output layer of the score prediction tower with an output layer of the bias prediction tower.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings arc. accordingly. to be regarded in an illustrative sense rather than a restrictive sense.

What is claimed is:

1. A method comprising:
using a score prediction tower of a deep learning model to generate and output predicted relevance scores for respective content items;
using a bias prediction tower of the deep learning model to generate and output bias prediction embeddings;
using an isotonic layer of the deep learning model to combine the relevance scores output by the score prediction tower with the bias prediction embeddings output by the score prediction tower;
by the isotonic layer, generating and outputting de-biased versions of the relevance scores based on the combination of the relevance scores with the bias prediction embeddings; and
providing the de-biased versions of the relevance scores for use by at least one application, system, model, service, process, or device.

2. The method of claim 1, wherein to generate the de-biased versions of the relevance scores, the isotonic layer simulates a step function.

3. The method of claim 2, wherein to simulate the step function, the isotonic layer applies a dot activation mechanism to the relevance scores.

4. The method of claim 2, wherein to simulate a step function, the isotonic layer applies a modified piecewise fitting mechanism to the relevance scores.

5. The method of claim 1, wherein during training of the deep learning model, output of the isotonic layer is used in backpropagation of the score prediction tower and not used in backpropagation of the bias prediction tower.

6. The method of claim 1, wherein during training of the deep learning model, the score prediction tower and the bias prediction tower are co-trained on same or different training data.

7. The method of claim 4, wherein the score prediction tower is trained using position-neutral training data and the bias prediction tower is trained using relevance-neutral training data.

8. The method of claim 1, wherein the bias prediction embeddings are representative of historical interactions with content items via a presentation mechanism of an online application that includes a plurality of bias-inducing elements.

9. The method of claim 1, wherein the isotonic layer of the deep learning model connects an output layer of the score prediction tower with an output layer of the bias prediction tower.

10. The method of claim 1, wherein the score prediction tower generates the predicted relevance scores independently of the bias prediction tower of the deep learning model.

11. The method of claim 1, wherein the bias prediction tower generates the bias prediction embeddings independently of the scoring tower.

12. The method of claim 1, further comprising providing the de-biased versions of the relevance scores for use by a presentation mechanism to configure the presentation of the content items with a plurality of bias-inducing elements in accordance with the de-biased versions of the relevance scores.

13. A system comprising:
at least one processor; and
at least one memory coupled to the at least one processor, wherein the at least one memory comprises at least one instruction that, when executed by the at least one processor, cause the at least one processor to perform at least one operation comprising:
using a score prediction tower of a deep learning model to generate and output predicted relevance scores for respective content items;
using a bias prediction tower of the deep learning model to generate and output bias prediction embeddings;
using an isotonic layer of the deep learning model to combine the relevance scores output by the score prediction tower with the bias prediction embeddings output by the score prediction tower;
by the isotonic layer, generating and outputting de-biased versions of the relevance scores based on the combination of the relevance scores with the bias prediction embeddings; and
providing the de-biased versions of the relevance scores for use by at least one application, system, model, service, process, or device.

14. The system of claim 13, wherein to generate the de-biased versions of the relevance scores, the isotonic layer simulates a step function; and wherein to simulate the step function, the isotonic layer at least one of applies a dot activation mechanism to the relevance scores or applies a modified piecewise fitting mechanism to the relevance scores.

15. The system of claim 13, wherein at least one of during training of the deep learning model, output of the isotonic layer is used in backpropagation of the score prediction tower and the output of the isotonic layer not used in backpropagation of the bias prediction tower, or the score prediction tower and the bias prediction tower are co-trained on same or different training data, wherein the score prediction tower is trained using position-neutral training data and the bias prediction tower is trained using relevance-neutral training data.

16. The system of claim 13, wherein the isotonic layer of the deep learning model connects an output layer of the score prediction tower with an output layer of the bias prediction tower.

17. The system of claim 13, wherein at least one of the score prediction tower generates the predicted relevance scores independently of the bias prediction tower of the deep learning model, or the bias prediction tower generates the bias prediction embeddings independently of the scoring tower.

18. At least one non-transitory machine-readable storage medium comprising at least one instruction that, when executed by at least one processor, causes the at least one processor to perform at least one operation comprising:
using a score prediction tower of a deep learning model to generate and output predicted relevance scores for respective content items;
using a bias prediction tower of the deep learning model to generate and output bias prediction embeddings;
using an isotonic layer of the deep learning model to combine the relevance scores output by the score prediction tower with the bias prediction embeddings output by the score prediction tower;
by the isotonic layer, generating and outputting de-biased versions of the relevance scores based on the combination of the relevance scores with the bias prediction embeddings; and
providing the de-biased versions of the relevance scores for use by at least one application, system, model, service, process, or device.

19. The at least one non-transitory machine-readable storage medium of claim 18, wherein to generate the de-biased versions of the relevance scores, the isotonic layer simulates a step function, and to simulate the step function, the isotonic layer applies a modified piecewise fitting mechanism to the relevance scores.

20. The at least one non-transitory machine-readable storage medium of claim 18, wherein the isotonic layer of the deep learning model connects an output layer of the score prediction tower with an output layer of the bias prediction tower.
